(19) United States
(12) Patent Application Publication
(10) Pub. No.: US 2007/0285365 A1
(43) Pub. Date: Dec. 13, 2007

(54) Liquid crystal display device and driving method thereof

(75) Inventor: Ki-Chan Lee, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/712,645

(22) Filed: Feb. 28, 2007

(30) Foreign Application Priority Data
Jun. 13, 2006 (KR) 10-2006-0052959

(51) Int. Cl. G09G 3/36

(52) U.S. Cl. 345/87

(57) ABSTRACT

A liquid crystal display, comprising a plurality of pixels, a data driver and a sense signal generator, where each of the pixels comprises a switch coupled to a data line and a liquid crystal capacitor. The liquid crystal capacitor is coupled to the switch and its capacitance is varied in response to external touch. The gate driver provides a gate signal to the pixel and the data driver provides data voltage to a data line. The sense signal generator generates a sensing signal by sensing a capacitance of the liquid crystal capacitor.

### CROSS-REFERENCE TO RELATED APPLICATION

This application claims priority to and the benefit of Korean Patent Application No. 10-2006-0052959 filed in the Korean Intellectual Property Office on Jun. 13, 2006, the entire contents of which are incorporated herein by reference.

### BACKGROUND OF THE INVENTION

(a) Field of the Invention

This invention relates to a liquid crystal display and the drive method thereof.

(b) Description of the Related Art

A liquid crystal display in general includes two substrates having a pixel electrode and a common electrode, and a dielectric anisotropic liquid crystal layer formed therebetween. The liquid crystal display displays image by controlling the strength of electric field applied to the liquid crystal layer and controlling the transmissivity of light passing through the liquid crystal layer.

A touch screen panel may be used in a computer where one can draw or write by touching an icon on screen with a finger or a touch pen.

An LCD with the touch screen panel determines whether a touch pen or finger of a user touches a screen the position of contact and informs the position of contact point. This type of LCD with a touch screen panel, however, results in disadvantages, such as cost increase, yield rate decrease, product thickness increase and luminance deterioration of display device due to a supplemental manufacturing process for making the touch screen panel.

### SUMMARY OF THE INVENTION

Therefore, this invention provides the method of sensing operation without transmittance deterioration in a liquid crystal.

In accordance with the first aspect of the present invention, the liquid crystal display provides: a data driver having an output terminal for applying a data voltage to a data line during displaying period, a gate driver for applying a gate voltage to a gate line, a pixel having a capacitor and a switching transistor, wherein a liquid crystal capacitor is charged with the first voltage and the switching transistor is coupled to the gate line and the data line, a sensing circuit for sensing a capacitance of the liquid crystal capacitor and generating a sensing signal and a comparing circuit for comparing the data voltage and the sensing signal.

The sensing circuit may further comprise an amplifier having a first input terminal, a second input terminal and a second node, a first capacitor coupled between the first input terminal and a first node, a second capacitor coupled between the first input terminal and the second node which is an output terminal of the amplifier, a first switch for alternatively connecting the data line with the first node and the output terminal of the data driver, a second switch for connecting the first node and a ground voltage and a third switch for connecting both end of the second capacitor.

The first switch is connected between the data line and the first node during a sensing period while the first switch is connected between the output terminal of the data driver and the data line except during the sensing period.

The amplifier amplifies a capacitance variation of the liquid crystal capacitor. The displaying period may comprise a sensing period.

In accordance with a second aspect of the present invention, the liquid crystal display provides: a display panel having an upper substrate and a lower substrate for displaying image, a plurality of pixel groups arranged in a pixel area, in which each pixel group has a plurality of pixels, a data driver having output terminals for applying data voltages to data lines, a gate driver for applying gate voltages to gate lines, a sensing signal generator coupled to the pixel groups and positioned on the lower substrate and a comparing circuit coupled to the sensing signal generators.

The sensing signal generator may comprise a plurality of sensing circuits.

Each of the sensing circuit further comprises: an amplifier having a first input terminal, a second input terminal and a second node, a first capacitor coupled between the first input terminal and a first node, a second capacitor coupled between the first input terminal and the second node which is an output terminal of the amplifier, a plurality of first switches for alternatively connecting the data lines with the first node or the output terminals of the data driver, a second switch for connecting the first node and a ground voltage, and a third switch for connecting both end of the second capacitor.

The plurality of first switches is commonly coupled to the first node during a sensing period while the plurality of first switches is commonly coupled to the output terminals of the data driver except during a sensing period.

In accordance with a third aspect of the present invention, the liquid crystal display provides a driving method of liquid crystal display which comprises the steps of: connecting an output terminal of a data driver to a data line by using a first switch, providing a data voltage from the data driver to a pixel, storing the data voltage to a liquid crystal capacitor in the pixel, connecting a sensing circuit to the data line by using the fist switch, sensing a capacitance of the liquid crystal capacitor, amplifying the data voltage by using the capacitance, generating a sensing signal in response to the amplified data voltage, and comparing the sensing signal with the data voltage in a comparing circuit.

### BRIEF DESCRIPTION OF THE DRAWINGS

FIG. 1 is a block diagram of a liquid crystal display according to one embodiment of this present invention.

FIG. 2 is an equivalent circuit of a pixel in a liquid crystal display according to the embodiment of this present invention.

FIG. 3 is a unit sensing circuit of a sensing signal generator in a liquid crystal display and an equivalent circuit of pixels connected thereto according to the embodiment of this present invention.

FIG. 4 is an equivalent pixel circuit for the unit sensing circuit shown in FIG. 3.

FIG. 5 is a signal waveform for describing operation of a liquid crystal display according to the embodiment of this present invention.

FIG. 6 is a block diagram of a plurality of pixels in a liquid crystal display panel according to another embodiment of this present invention.

FIG. 7 is a signal wave form diagram showing the operation of a liquid crystal display having the LCD panel assembly of FIG. 6.

FIG. 8 is a circuit diagram of a detection unit suitable for use in practicing the present invention.

### DETAILED DESCRIPTION OF THE EMBODIMENTS

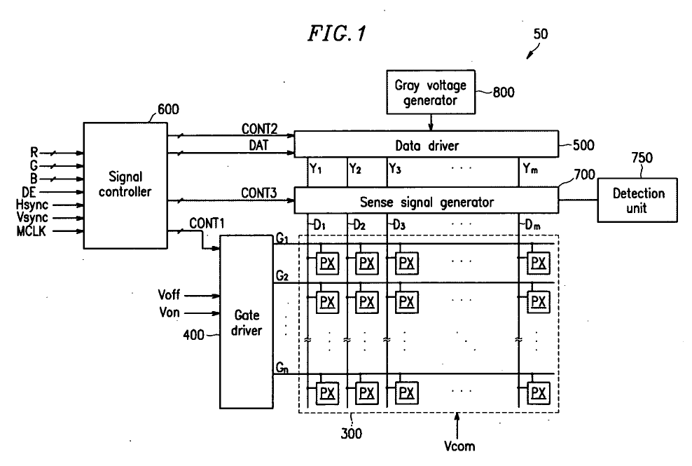

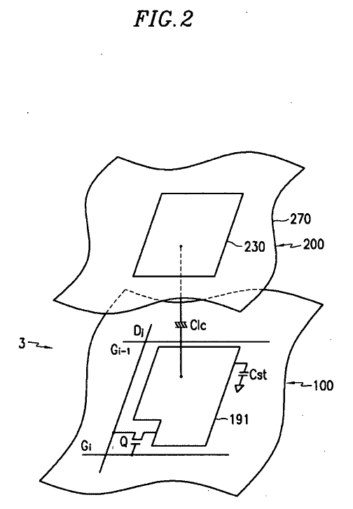

Reference will now be made in detail to the preferred embodiment of this present invention, examples of which are illustrated in the accompanying drawings. Referring to FIG. 1 and FIG. 2, a liquid crystal display of display device is to be illustrated in detail.

FIG. 1 illustrates a block diagram of an LCD according to one embodiment of this present invention and FIG. 2 illustrates an equivalent circuit of a pixel in an LCD according to the embodiment of this present invention.

Referring to FIG. 1, liquid crystal display 50 includes a pixel area 300, a gate driver 400 and a data driver 500 both coupled to the pixel area 300, a gray voltage generator 800 coupled to the data driver 500, a sense signal generator 700, a detection unit 750 coupled to the sense signal generator 700 and a signal controller 600 controlling all of them. The pixel area 300 comprises a plurality of gate lines G1-Gn, data lines, D1-Dm coupled with a plurality of plural pixels PX which are arranged in matrix form. Meanwhile, referring to FIG. 2, a liquid crystal display 50 includes a liquid crystal layer 3 interposed between a lower substrate 100 and an upper substrate 200 in a pixel area 300.

As shown in FIG. 1, gate lines G1-Gn transfer gate signals and data lines D1-Dm provide data voltage to the pixel area 300. Gate lines G1-Gn are formed in parallel to each other and in a row direction; and data lines D1-Dm are formed in a column direction and parallel to each other.

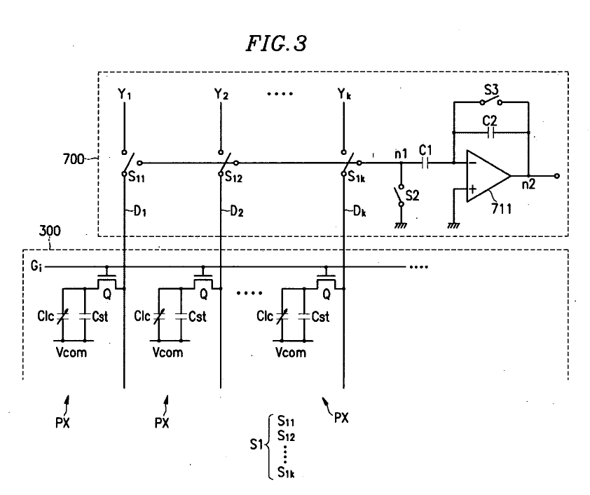

In FIG. 3, each pixel PX in the pixel area 300 includes a switch Q, a liquid crystal capacitor Clc and a storage capacitor Cst as an equivalent circuit wherein the switch Q is coupled with i'th gate line Gi (i=1, 2, . . . ) and j'th data line Dj (j=1, 2, . . . ) and the storage capacitor Cst.

The switch Q has three terminals. A first terminal, a gate, for controlling the conduction of transistor Q, is connected to a gate line Gi; a second terminal, a source, for receiving data voltage is connected to a data line Dj; a third terminal, a drain, for providing pixel voltage is connected to both a liquid crystal capacitor Clc and a storage capacitor Cst.

In FIG. 2, the liquid crystal capacitor Clc results from a liquid crystal layer 3 interposed between a pixel electrode 191 on lower substrate 100 and a common electrode 270 on upper substrate 200. The pixel electrode 191 is coupled with the drain of the switch Q. The common electrode 270 is formed on the whole surface of upper substrate 200 and receives a common voltage Vcom. Unlike FIG. 2, the common electrode 270 may be formed on the lower substrate 100 wherein the pixel electrode 191 has a linear type electrode while the common electrode 270 has a bar type electrode, or vice versa.

When a user touches the pixel area 300, a distance between the common electrode 270 and the pixel electrode 191 is varied so that capacitance of the liquid crystal capacitor Clc is changed with other value. Accordingly, the liquid crystal capacitor Clc may be considered as a variable capacitor because it varies its capacitance.

The storage capacitor Cst which functions as an ancillary part of the liquid crystal capacitor Clc is formed between a pixel electrode 191 and a storage signal line (not shown) on the lower substrate 100 in which insulator is interposed therebetween, and the storage signal line may receive a predetermined voltage such as a common voltage Vcom. The storage capacitor Cst, however, may be formed on a previous gate line by overlapping with the pixel electrode 191 where insulator is interposed therebetween.

There are several methods for displaying colors on the screen of liquid crystal display. For example, each pixel PX continually displays one of their own primary colors, which is called as a space division method, or each pixel PX alternatively displays their own primary colors within a predetermined time, which is called as a time division method, so that the expected colors are displayed on the screen by mixing red, green and blue color. FIG. 2 shows a pixel PX comprising a color filter 230, which faces to the pixel electrode 191, and displaying its own primary color on the upper substrate 200. It can be used in the space division method. Unlike FIG. 2, the color filter 230 may be formed above or beneath the pixel electrode 191 of the lower substrate 100.

At least one polarizer (not shown) for polarizing light is formed on out-surface of the liquid crystal display 50.

Referring to FIG. 1, a gray voltage generator 800 generates two sets of gray voltages which relate to transmittance of each pixel PX. One set has positive voltage and the other set has negative with respect to the common voltage Vcom.

Gate driver 400 is coupled to the gate lines G1-Gn in the pixel area 300, and applies gate signals, which are composed of gate turn on voltage Von and a gate turn off voltage Voff, to the gate lines G1-Gn.

Data driver 500 is coupled to the data lines (D1-Dm) in the pixel area 300, and receives gray voltages from the gray voltage generator 800, and thereafter applies them to the data lines D1-Dm as a data voltage.

Sense signal generator 700 in one embodiment is positioned on a lower substrate 100 between data driver 500 and pixel area 300. It may of course be located in a different location. When a user touches the screen, the sense signal generator 700 senses the variation of capacitance of liquid crystal capacitor Clc and amplifies it and provides an output sensing signal. The circuitry and operation of the sense signal generator 700 is described below.

This sense signal generator 700 may be combined with data driver 500 and also may be formed on a special chip.

Detection unit 750 is coupled with a sense signal generator 700 and finds out whether touch is performed. A touch location may find by using the sense signal received from the sense signal generator 700. Detection unit 750 may include an analog-to-digital converter or may be embedded in a signal controller 600. The signal controller 600 controls a gate driver 400 and a data driver 500, and sense signal generator 700.

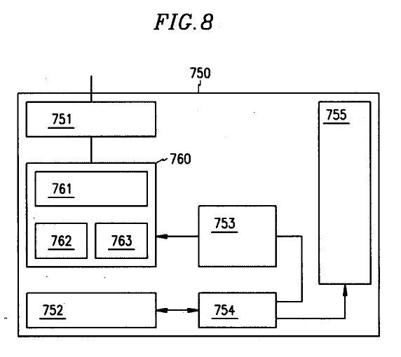

The circuitry for detection unit 750 is shown in FIG. 8 and the operation thereof is as follows.

As shown in FIG. 8, the detection unit 750 according to the exemplary embodiment of the present invention includes an analog-to-digital converter 751, a first and second controllers 760 and 753, a register unit 754, memory 752, and an interface 755.

The analog-to-digital converter 751 receives analog sensing signal from the sense signal generator 700 and converts the analog sensing signals to digital sensing signals. The digital sensing signals are based on the difference of current sensing signals and previous sensing signals.

The first controller 760 includes a memory 761, a data classifying unit 762, and a touch state checking unit 763. These components are constructed with hard wired logic. The first controller 760 may further include an initializing unit (not shown) which controls an initial operation of the detection unit 750.

The data classifying unit 762 reads the digital sensing signals from the analog-to-digital converter 751 and classifies the digital sensing signals into vertical sensing signal and horizontal sensing signals. After that, the data classifying unit 762 transmits the vertical and horizontal sensing signals to the memory 761 to store the signals in the memory 761.

The touch state checking unit 763 checks whether or not the touch operation on the sensing units SU is performed by using one of the vertical and horizontal sensing signals.

The second controller 753 is a processor such as an ARM. The second controller 753 determines the touch occurrence and touched position on the sensing units SU.

The register unit 754 stores flag values indicating operational states of components.

The memory 752 is a flash memory. The memory 752 and it stores operational programs which operate the second controller 753.

The interface 755 may be a serial peripheral interface (SPI). The interface 755 and it transmits touch information or control signals from external apparatuses and receives required data and control signals from external apparatuses.

Driving means 400, 500, 600, 700, 750, 800 can be formed on the pixel area 300 in which gate lines G1-Gn, data lines D1-Dm and a thin film transistor switch Q are formed. Alternatively, the driving means 400, 500, 600, 700, 750, 800 may be attached directly to the liquid crystal display 50 in the form of integrated circuit chip or a tape carrier package (TCP) which comprises a flexible printed circuit film (not shown) or a special printed-circuit board (not shown).

Also, the driving means 400, 500, 600, 700, 750, 800 may be integrated within one chip and at least one of above driving means or its circuitry may be formed outside of the chip.

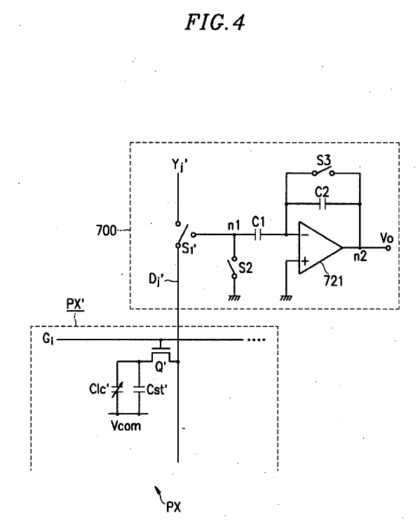

Sense signal generator 700 is illustrated in FIG. 3 and FIG. 4.

FIG. 3 shows a unit sensing circuit of a sensing signal generator in a liquid crystal display and an equivalent circuit of pixels connected thereto according to an embodiment of this present invention. FIG. 4 is an equivalent pixel circuit for the unit sensing circuit shown in FIG. 3.

The sense signal generator 700 includes several sensing circuits as shown in FIG. 3 in the pixel area 300. The sensing circuits in sense signal generator 700 comprise a switched capacitor amplifier. It includes an input capacitor C1, a feedback capacitor C2, an input switch S1, a discharging switch S2 and an amplifier 711. The amplifier 711 feeds back some of the output to its inverting input terminal through a feedback capacitor C2 and a feedback switch S3. One end of the input capacitor C1 is coupled to the inverting input terminal of amplifier 711 and the other end of the input capacitor C1 is coupled to an input switch S1 and a discharging switch S2. The other input of the amplifier 711 has positive polarity, which is referred to as the noninverting input terminal. Generally, the noninverting input terminal is grounded. The input switch S1 comprises several switches S₁₁, S₁₂, . . . , S₁ₖ.

Input switch S1 comprising several input switches S₁₁-S₁ₖ are commonly controlled and connects the data lines D1-Dk in pixel area 300 to output terminals Y1-Yk of the data driver 500 or a first node n1 of the sensing circuit 710 in response to the control signal (not shown).

One terminal of capacitor C1 is connected to the inverting input terminal of amplifier 711 and the other terminal of C1 is connected to lines D1 through Dk via switches S₁₁ through S₁ₖ during a sensing period.

Any charge on input capacitor C1 is discharged by grounding a first node n1 based on a control signal (not shown) of a discharge switch S2 during a discharging period.

Also, a charge on feedback capacitor C2 is discharged by the control signal (not shown) of feedback switch S3.

A plurality of pixels PX are coupled to sense signal generator 700 and for convenience of explanation a simplified circuit is shown in FIG. 4. Sense generator 700 may be represented by one pixel PX′ as shown in FIG. 4 and a plurality of liquid crystal capacitors Clc may be represented by a liquid crystal capacitor Clc′. Electrostatic capacity of liquid crystal capacitor Clc′ is the same as the sum of electrostatic capacity of plural liquid crystal capacitors Clc.

Like a liquid crystal capacitor Clc′ in FIG. 4, a plurality of storage capacitors Cst may be represented by a storage capacitor Cst′ and plural switches Q may be represented by a switch Q′. Moreover, plural input switches S11-S1k may be represented by one input switch S1′

An operation of the liquid crystal display 50 is as follows below.

Signal controller 600 receives input video signals R, G, B and an input control signal for controlling them from external graphic controller (not shown. The input video signals R, G, B contain luminance information of each pixel PX, wherein the luminance may be classified into a lot of grays, for example, having 1024 (=210), 256 (=28) or 64 (=26) grays.

Example of input control signal is a vertical sync signal Vsync and a horizontal synchronization signal Hsync, a main clock MCLK and a data enable signal DE, etc.

The signal controller 600 generates a gate control signal CONT1 and a data control signal CONT2 in response to the input video signals R, G, B and the input control signal. The gate control signal CONT1 is provided to gate driver 400 and the data control signal CONT2 and a video signal DAT are provided to the data driver 500. A sensing control signal CONT3 from the signal controller 600 is provided into a sense signal generator 700.

The gate control signal CONT1 includes an injection start signal STV which indicates the start of injection and at least one clock signal which controls output cycle of gate all voltage Von. The gate control signal CONT1 may comprise an output enable signal OE which limits duration time of gate on voltage Von.

The data control signal CONT2 comprise a horizontal synchronization start signal STH indicating that the transmission of the digital video signal DAT for pixel PX starts to begin, a load signal LOAD and a data clock signal HCLK which indicate that analog data voltage is provided to data lines D1-Dm.

Data control signal CONT2 may include reversal signal RVS which makes the polarity of analog data voltage reverse comparing to common voltage Vcom. The polarity of data voltage comparing to the common voltage may be called as the polarity of data voltage.

Sensing control signal CONT3 may control first to the third switching control signal which controls input switches such as S1, S2, S3.

Signal controller 600 may separately control sensing period during displaying period. During the sensing period, the variation of liquid crystal capacitor Clc is sensed in the sensing circuit 720 and is compared with previous capacitance of the liquid crystal capacitor Clc. When user touches screen, a detection unit 750 finds touch information based on variation between sensed capacitance and previous capacitance. During displaying, data is transferred and variation of liquid crystal capacitor Clc is sensed.

The operation of this invention for the liquid crystal display 50 is as follows.

In response to the data control signal CONT2 from signal controller 600, the data driver 500 receives a digital video signal DAT for the pixels PX of one column. A gray voltage corresponding to each digital video signal is selected and is changed as an analog image data voltage. Finally, the data driver outputs the analog image data voltage to output terminal Y1-Ym. The output terminals, Y1-Ym, are coupled to the data lines D1-Dm by the control signal (not shown).

By applying gate on voltage Von to gate lines G1-Gn in response to the gate control signal CONT1, a gate driver 400 makes switches Q coupled to the gate lines G1-Gn turn on. Then, image data voltage applied to the data lines D1-Dm is transferred to each pixel PX through the turned-on switches Q.

Voltage difference between data voltage applied to pixel and common voltage Vcom is expressed as a charged voltage in a liquid crystal capacitor Clc such as a pixel voltage Vpx. Liquid crystal molecules are differently inclined according to the level of pixel voltage Vpx. Therefore, the light passing through liquid crystal layer 3 is varied according to polarization rate. The polarization variation exhibits transmissivity of light by polarizer attached on liquid crystal panel assembly 300 and shows the brightness of pixel PX having a gray of video signal DAT.

Above operation is repeatedly activated every one horizontal cycle, which is called “1H” and has the same cycle with horizontal synchronization signal Hsync and data enable signal DE. Accordingly, all gate lines G1-Gn receive gate on voltage Von in sequence and therefore all pixels PX receive data voltage so that image of one frame may be shown.

If operation of one frame ends and that of the other frame starts, data voltage having opposite polarity for previous polarity is applied to each pixel PX based on a reversal signal RVS applied on data driver 500. It is generally called as a frame inversion.

It may vary the polarity of data voltage based on every data line (line inversion or dot inversion) or every pixel (column inversion or dot inversion) within one frame.

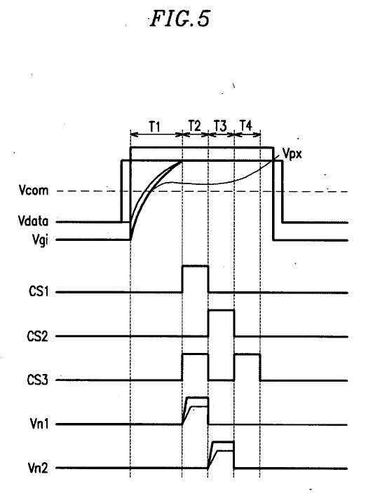

Through FIG. 4 and FIG. 5, the operation of liquid crystal display 50 is explained below a sensing period.

FIG. 4 is an equivalent pixel circuit for the unit sensing circuit shown in FIG. 3. FIG. 5 is a signal waveform for describing operation of a liquid crystal display according to the embodiment of this present invention.

Referring to FIG. 4 and FIG. 5, data driver 500 provides a data voltage for pixels in one line to output terminal Yj′. Gate driver 400 applies gate on voltage Von to a gate line Gi and turns on switch Q′ which is coupled to the gate line Gi. As an input switch S1′ connects both an output terminal Yj′ of data driver 500 and a data line Dj′ during the first period T1, the data voltage is provided to a liquid crystal capacitor Clc′ and a storage capacitor Cst′ corresponding to pixel PX′ through the switch Q′ which is turned on.

During the second period T2, data line Dj′ is connected to a first node n1 of sense signal generator 700 through the input switch S1′ in response to a switching control signal CS1 while a discharging switch S2 is open in response to a second switching control signal CS2. Feedback switch S3 is turned on, or closed, during periods T2 and T4 in response to a third switching control signal CS3, thus discharging capacitor C2. As a liquid crystal capacitor Clc′ and a storage capacitor Cst′ are serially connected with an input capacitor C1, when three capacitors, a liquid crystal capacitor Clc′, a storage capacitor Cst′ and an input capacitor C1, have the same electric charge, the voltage level of the first node n1 is determined because charge in a liquid crystal capacitor Clc′ and a storage capacitor Cst′ is transferred to the input capacitor C1.

In this time, output voltage of second node n2 is preserved 0V such as an inverting input (−) and a noninverting input of amplifier 711 and voltage Vn1 of the first node n1 is charged to the input capacitor C1.

During the third period T3, data line Dj′ and Yj′ are reconnected by the input switch S1′. As the discharging switch S2 closes and the feedback switch S3 is opened, voltage Vn1 of the first node n1 becomes 0V. From this point, electric charge charged in input capacitor C1 is moved to the feedback capacitor C2 and an equation for voltage Vn2 of output terminal, second node n2, is given as follows.

Vn2=Vn1₀*C1/C2

Vn2=Vn1₀*C1/C2

Wherein, Vn1₀ is voltage Vn1 of the first node n1 in the second period T2; C1 is electrostatic capacity of input capacitor C1; C2 is electrostatic capacity of feedback capacitor C2.

According to rate of electrostatic capacity of the input capacitor C1 versus the feedback capacitor C2, voltage Vn2 of amplified output terminal n2 is provided to detection unit 750 as a sensing signal. In the detection unit 750, as the sensing signal is compared with previously charged voltage, it is possible to find whether user touches a screen

Finally, during the fourth period T4, as the discharging switch S2 is opened and the feedback switch S3 is closed, input capacitor C1 and feedback capacitor C2 are initialized.

The operation through the first to fourth periods T1-T4 is accomplished within one horizontal period “1H” while a pixel PX′ receives gate on voltage Von. Accordingly, high speed driving is achieved by using a switched capacitor amplifier circuit in sense signal generator 700.

When user presses a screen in pixel area 300 by finger, or stylus, a distance interval between upper substrate 200 and lower substrate 100 is decreased. As the distance interval between common electrode 270 of upper substrate 200 and pixel electrode 191 of lower substrate 100 is decreased, electrostatic capacity of liquid crystal capacitor Clc′ is increased.

While the output terminal Yj′ of data driver 500 is connected with data line Dj′ by input switch S1′, if user presses a screen above the display pixel area 300, electrostatic capacity charged in liquid crystal capacitor Clc′ varies according to the change of capacitance.

Such change of these electric capacity affects voltage Vn1 of the first node n1 when liquid crystal capacitor Clc′ and input capacitor C1 which are connected in series are balanced in capacitance during the second period T2. During the second period T2, the voltage Vn1 of the first node n1 is decided by the ratio between electric capacity of liquid crystal capacitor Clc′ versus sum of both electrostatic capacity of liquid crystal capacitor Clc′ and input capacitor C1 so that voltage Vn1 of the first node n1 is increased according to the increase of electric capacity of liquid crystal capacitor Clc′.

Therefore, voltage Vn1 of the first node n1 in the position where user touches the screen has higher voltage than that of other area where user does not touch the screen. The rising of voltage Vn1 of first node n1 is proportional to the pressure intensity.

Finally, sense signal generator 700 generates a sensing signal by amplifying the voltage Vn1 of the first node n1 and provides it to detection unit 750. The detection unit 750 compares the sensing signal with the previous data voltage. So, the contact information and position information can be found.

As explained above, the previous data voltage may be image data voltage or black data voltage. The black data voltage is different from the image data voltage.

When two image data are sequentially displayed in the pixel area 300, the black data voltage is provided therebetween for preventing blurring effect. Namely, it creates an impulsive effect for preventing blurring phenomena so that the quality of moving images can be improved.

When user touches the screen while input switch S1′ is connected between data line Dj′ and first node n1, the capacitance variation of liquid crystal capacitor Clc′ invokes the variation of pixel voltage Vpx while pixel electrode is in floating state because liquid crystal capacitor Clc′ has already been charged with the certain level of electrostatic capacity.

Therefore, the sense signal generator 700 amplifies the variation of pixel voltage Vpx during the third period T3 and creates a sensing signal.

Thus, a liquid crystal display 50 according to one embodiment of this invention generates a sensing signal by sensing the variation of capacitance charged in liquid crystal capacitor Clc′ or variation of pixel voltage Vpx during the sensing period. Finally, the detection unit 750 deciphers contact information by using the sensing signal and the previous data voltage.

Though the sensing period may placed in every frame period, it is possible to place every several frame periods.

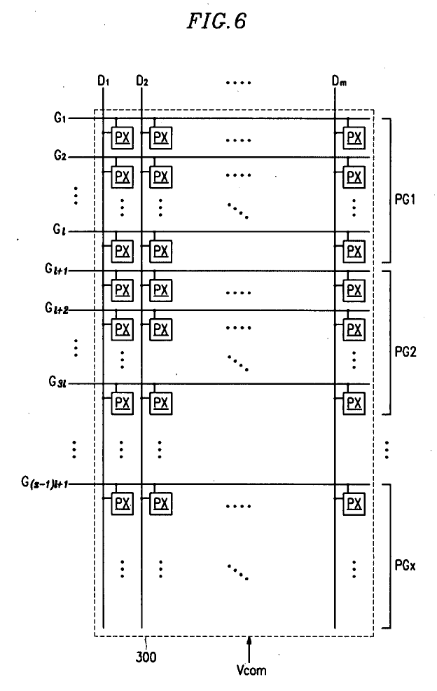

FIG. 6 is a block diagram of a plurality of pixels in a liquid crystal display panel according to another embodiment of this present invention. Referring to FIG. 6, the pixel area 300 of liquid crystal display 50 may include plural pixel groups PG1, PG2, PGx, in which each group includes plural pixels.

The size of each group may be decided within the area where sensing is accomplished. As pixels are divided into several groups and sensing operation is activated in each group, power consumption can be reduced.

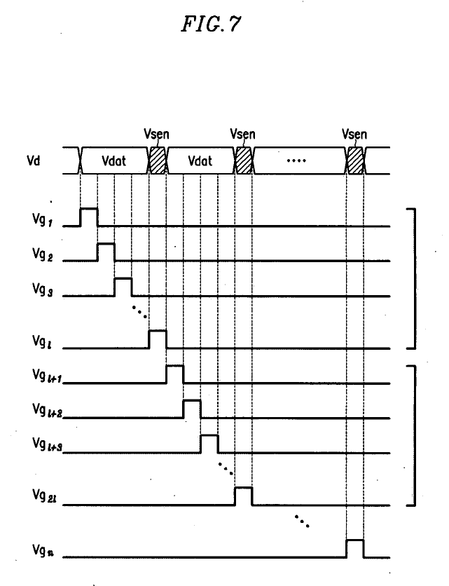

Hereinafter, another operation of the liquid crystal display will be described with reference to FIGS. 6 and 7.

FIG. 6 is a block diagram of a LC panel assembly in a liquid crystal display in accordance with another exemplary embodiment of the present invention, and FIG. 7 is a signal waveform diagram showing the operation of a liquid crystal display having the LC panel assembly of FIG. 6.

Referring to FIG. 6, the LC panel assembly of the liquid crystal display in accordance with another exemplary embodiment of the present invention includes a plurality of pixel groups PG1, PG2, . . . , PGx including a plurality of pixel rows, i.e., an I-number of pixel rows.

At this time, the size of one pixel group PG1, PG2, . . . , PGx, i.e., the number of I, is determined within the range of spatial areas that are capable of sensing whether or not a touch occurs within a touch point.

The operation in the display sections of the liquid crystal display of FIG. 6 is the same as the operation of the liquid crystal of FIG. 5.

In the display sections, a sense data voltage Vsen is optionally supplied to a few rows of pixels PX of one pixel group PG1, PG2, . . . , PGx, i.e., a row of pixels PX of one pixel group PG1, PG2, . . . , PGx, as shown in FIG. 7, and an image data voltage is supplied to the other pixel rows of pixels. Accordingly, the input switching element S1′ connects the data lines D1-Dm and the output terminals Y₁-Yₘ of the data driver 500, and only when the sense data voltage Vsen is outputted from the data driver 500 does it connect the data lines D₁-Dₘ and the node n1 of the sense signal generator 700.

In this manner, the plurality of pixels PX is grouped in blocks such that a sensing operation is performed for each block, thereby reducing power consumption.

At this time, the sense data voltage Vsen may be a black data voltage that represents black, as shown in FIG. 7, or an image data voltage that displays a typical image.

As above, according to the present invention, sense information is optionally read using the LC capacitor performing a display operation without mounting any sensor, so that an aperture ratio is ensured and a sensing operation is enabled.

Further, it is possible to obtain an impulsive effect by displaying a black image when performing a sensing operation.

1Thus, according to this invention, it is possible to get touch information without attaching any other sensing apparatus and a sensing operation can be done without loss of aperture ratio. Also, it is possible to get impulsive effect by displaying black image during the sensing operation.

While the embodiments of the present invention have been described using specific terms, such description is for illustrative purposes only, and it is to be understood that changes and variations may be made without departing from the spirit or scope of the following claims.

What is claimed is:

1. A liquid crystal display, comprising:
a data line;
a gate line;
a data driver having an output terminal for applying a data voltage to the data line during a display period;
a gate driver for applying a gate voltage to the gate line;
a pixel comprising a liquid crystal capacitor coupled to a switching transistor, wherein the liquid crystal capacitor is charged to a voltage via the switching transistor which is coupled to the gate line and the data line;
a sense signal generator having an input and being adapted to sense a capacitance value of the liquid crystal capacitor and generate a sense signal; and
a first switch operable to selectively couple the sense signal generator to the liquid crystal capacitor.

2. The liquid crystal display according to claim 1 wherein the sense signal generator comprises a switched capacitor amplifier.

3. The liquid crystal display according to the claim 2, wherein the switched capacitor amplifier comprises:
an input node;
an amplifier having a first input terminal, a second input terminal and a an output terminal;
a first capacitor coupled between the first input terminal and the input node;
a second capacitor coupled between the first input terminal and the second node which is an output terminal of the amplifier;
a second switch for selectively connecting the first node to the second input terminal; and
a third switch for selectively connecting the first input terminal to the output terminal.

4. The liquid crystal display according to the claim 3, wherein the first switch couples the liquid crystal capacitor to the input node during a sensing period.

5. The liquid crystal display according to the claim 4, wherein the first switch is operable to connect the data line to the switching transistor during a time other than during the sensing period.

6. The liquid crystal display according to the claim 2, wherein the switched capacitor amplifier amplifies a capacitance variation of the liquid crystal capacitor.

7. The liquid crystal display according to the claim 1, wherein the displaying period may comprise a sensing period.

8. A liquid crystal display, comprising:
a plurality of data lines;
a plurality of gate lines;
a display panel having an upper substrate and a lower substrate for displaying image;
a plurality of pixels arranged in a matrix in a pixel area, in which each pixel group has a plurality of pixels;
a data driver having output terminals for applying data voltages to associated data lines;
a gate driver for applying gate voltages to associated gate lines;
a sense signal generator coupled to the pixel groups and positioned on the lower substrate;
a plurality of first switches operable to selectively couple the sense signal generator to the pixels; and
a comparing circuit coupled to an output of the sense signal generator.

9. The liquid crystal display according to the claim 8, wherein the sense signal generator comprises a plurality of sensing circuits.

10. The liquid crystal display according to the claim 9, wherein each sense circuit comprises:
an input node;
an amplifier having a first input terminal, a second input terminal and a an output terminal;
a first capacitor coupled between the first input terminal and the input node;
a second capacitor coupled between the first input terminal and the second node which is an output terminal of the amplifier;
a second switch for selectively connecting the first node to the second input terminal; and
a third switch for selectively connecting the first input terminal to the output terminal.

11. The liquid crystal display according to the claim 10, wherein the plurality of first switches is commonly coupled to the first node during a sensing period.

12. The liquid crystal display according to the claim 10, wherein the plurality of first switches is commonly coupled to the output terminals of the data driver except during a sensing period.

13. A driving method of liquid crystal display, comprising:
connecting an output terminal of a data driver to a data line by using a first switch;
providing a data voltage from the data driver to a pixel which includes a liquid crystal capacitor;
selectively connecting a sense circuit to the pixels;
sensing a capacitance of the liquid crystal capacitor;
amplifying the data voltage by using the capacitance;
generating a sensing signal in response to the amplified data voltage; and
comparing the sensing signal with the data voltage in a comparing circuit.

14. A driving method of liquid crystal display according to the claim 13, wherein sensing the capacitance is performed during a sensing period.

15. A driving method of liquid crystal display according to the claim 13, further comprising storing the data voltage to a storage capacitor.

16. A driving method of liquid crystal display according to the claim 13, further comprising disconnecting the sense circuit from the pixels after sensing the capacitance.
